(19) United States
(12) Patent Application Publication
(10) Pub. No.: US 2010/0082126 A1
(43) Pub. Date: Apr. 1, 2010

(54) CONTROL DEVICE, CONTROL PROGRAM, AND CONTROL METHOD

(75) Inventor: Hiroki Matsushita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/563,620

(22) Filed: Sep. 21, 2009

(30) Foreign Application Priority Data
Oct. 1, 2008 (JP) 2008-256376

(51) Int. Cl. G05B 9/03; G06N 3/02

(52) U.S. Cl. 700/48; 706/23; 700/82; 706/15

(57) ABSTRACT

According to one embodiment, a control device that controls operation of a system includes a first selecting module, a second selecting module, a control error measuring module, a determining module, and a control module. The first selecting module selects a first neural network from neural networks different in network configuration from each other. The second selecting module selects a second neural network different from the first neural network from the neural networks. The control error measuring module measures first control error in control by the first neural network and second control error in control by the second neural network. The determining module compares the first control error and the second control error measured by the control error measuring module, and determines a neural network with less control error. The control module controls the operation of the system by the neural network with less control error determined by the determining module.

### CROSS-REFERENCE TO RELATED APPLICATIONS

This application is based upon and claims the benefit of priority from Japanese Patent Application No. 2008-256376, filed on Oct. 1, 2008, the entire contents of which are incorporated herein by reference.

### BACKGROUND

1. Field

One embodiment of the invention relates to a control technology using a neural network.

2. Description of the Related Art

In recent years, with a high density of write data with respect to a storage medium in a disk device, such as a magnetic disk device, a track pitch of the storage medium has been narrowed, and control of a head has been difficult. Further, as a control frequency and request density in the disk device have been increased, an influence due to a separation between required control and control based on a basic control model by actuator resonance has been increased. As a countermeasure with respect to the actuator resonance, a notch filter is generally inserted, but this causes a phase delay. For this reason, it is difficult to configure a multi-stage, and it is difficult to apply the countermeasure to a complex system.

Accordingly, a technology for applying neural network control as nonlinear control suitable for the complex system to control for the disk device has been known. Here, a neural network as an example of a general hierarchical network model, and an error propagation method (back-propagation method) as a general learning method thereof will be described. First, the neural network will be described using FIGS. 15 to 17. FIG. 15 is a diagram of the outline of a neural network. FIG. 16 is a diagram of expressions that are related to a hierarchical neural network. FIG. 17 is a graph illustrating a sigmoid function.

As illustrated in FIG. 15, the neural network based on the hierarchical network model is configured by an input layer comprising input nodes, a hidden layer comprising hidden nodes, and an output layer comprising an output node. The input node receives an input value. Further, the hidden node calculates a value based on the input node (hidden layer node value). Further, the output layer outputs a final value with respect to the input value, on the basis of the hidden layer node value. In FIG. 15, a circle indicates a node, a line indicates a link, X indicates an input value, W indicates weight of a link between the input layer and the hidden layer, H indicates a hidden layer node value, and n indicates an output value. The neural network illustrated in FIG. 15 is a 4-3-1 hierarchical neural network that comprises the above-described nodes, specifically, four input nodes, three hidden nodes, and one output node.

In the hierarchical neural network, an input value Xᵢ and a hidden node value Hⱼ are associated with each other by a logistic function f(x) that is a transfer function between weight Wᵢⱼ and a node illustrated in an expression 1 of FIG. 16. Further, the hidden node value Hⱼ and the output value n are associated with each other by weight Vⱼ and a logistic function f(x) that is a transfer function between the nodes illustrated in an expression 2 of FIG. 16. In the expressions 1 and 2 of FIG. 16, k indicates a time. Further, in the hierarchical neural network illustrated in FIG. 15, a sigmoid function illustrated in FIG. 17 is generally adopted as the logistic function. If the sigmoid function is represented as an expression, this becomes an expression 3 of FIG. 16. Further, for an error back-propagation method to be described in detail below, a relationship between ∂f(x)/∂x and f(x) is calculated, as illustrated in an expression 4 of FIG. 16.

In the error back-propagation method as a learning method of the neural network, the weights Wᵢⱼ and Vⱼ are sequentially corrected in proportional to an error, in order to decrease a square error of a measurement value and an instruction value. Hereinafter, the error back-propagation method will be described using expressions. FIG. 18 is a diagram of expressions that are related to an error back-propagation method.

On the assumption that eₚ(k) is an output deviation at a time k and n(k) is a control output value at the time k, J(k) proportional to a square error of eₚ(k) and n(k) is defined as illustrated in an expression 1 of FIG. 18. In the error back-propagation method, a learning is progressed such that a value of J(k) is minimized. In this case, if the output deviation eₚ(k) is the neural network output n(k), a target t(k), and a control object output y(k), the amount represented by an expression 2 of FIG. 18 becomes an instructor signal of the neural network.

Further, as the learning amount with respect to the link weight Vⱼ between the output node n(k) and the hidden node value Hⱼ to minimize an error J(k) of the time k, ΔVⱼ(k) is defined as illustrated in an expression 4 of FIG. 18. Further, in the error back-propagation method, the learning amount ΔVⱼ(k) is −η times as much as the influence amount ∂J(k)/∂Vⱼ(k) of Vⱼ(k) with respect to J(k). Further, η indicates learning sensitivity of a neuron that can be arbitrarily determined, and a symbol − indicates a correction. By this definition, ΔVⱼ(k) is as illustrated in an expression 5. By expressions 6 and 7 illustrated in FIG. 18, ΔVⱼ(k) becomes the learning amount that is directly proportional to an error e(K) illustrated in an expression 8.

Similar to the definition with respect to the link weight Vⱼ, as the learning amount with respect to the link weight Wᵢⱼ between the hidden node value Hⱼ and the input value Xᵢ to minimize an error J(k) of the time k, ΔWᵢⱼ(k) is defined as illustrated in an expression 9 of FIG. 18. In this case, ΔWᵢⱼ(k) is as illustrated in an expression 10.

As described above, using the error back-propagation method, the hierarchical neural network sequentially performs a calculation of ΔWᵢⱼ(k) and performs a correction, and optimizes the link weights Vⱼ and Wᵢⱼ.

An original neuron exhibits a step functional response that abruptly reacts at an indifferentiable threshold value or more, as known even in a research of Sepiotenthis lessoniana. As descried above, however, in the neural network, if a differentiable function, such as the sigmoid function, is adopted as the logistic function, an analytical exact solution of an optimal learning can be obtained by using a method, such as the error back-propagation method.

Further, when an analysis based on the error back-propagation method is performed, a calculation related to the analysis becomes extraordinarily complicated. However, the neural network can be constructed using another network model, such as a recurrent network model, instead of the hierarchical network model.

For example, Japanese Patent Application Publication (KOKAI) No. 2003-330505 discloses, as a conventional technology, a control method and a control device that can compensate for periodic disturbance in a servo system by controlling the operation of a system by a neural network.

However, the control by the neural network as the complex system nonlinear control as described above needs large CPU/DSP power to handle the sigmoid function instead of a power series as a computer. Further, when a neural network having high usability is formed, nodes and links of an input layer and a hidden layer need to be increased, which results in increasing a calculation load. The above conventional technology uses an analog VLSI dedicated for calculation related to the neural network as the countermeasure to the calculation load. However, a large amount of time and cost are required to form a dedicated IC.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a disk device according to a first embodiment of the invention;

FIG. 2 is an exemplary diagram of a neural network A in the first embodiment;

FIG. 3 is an exemplary diagram of a neural network B in the first embodiment;

FIG. 4 is an exemplary flowchart of the entire operation of the disk device in the first embodiment;

FIG. 5 is an exemplary flowchart of the operation of a switching process in the first embodiment;

FIG. 6 is an exemplary diagram of the outline of a link changing process in the first embodiment;

FIG. 7 is an exemplary flowchart of the operation of a link changing process in the first embodiment;

FIG. 8 is an exemplary flowchart of the operation of a link changing process in the first embodiment;

FIG. 9 is an exemplary diagram of a look-up table of a sigmoid function according to a second embodiment of the invention;

FIG. 10 is an exemplary diagram of a look-up table of a derived function of a sigmoid function in the second embodiment;

FIG. 11 is an exemplary diagram of a classification table according to a third embodiment of the invention;

FIG. 12 is an exemplary flowchart of the operation of a switching process in the third embodiment;

FIG. 13 is an exemplary diagram of a changed classification table in the third embodiment;

FIG. 14 is an exemplary diagram of a computer system according to an embodiment of the invention;

FIG. 15 is an exemplary diagram of the outline of a neural network;

FIG. 16 is an exemplary diagram of expressions related to a hierarchical neural network;

FIG. 17 is an exemplary graph of a sigmoid function; and

FIG. 18 is an exemplary diagram of expressions related to an error back-propagation method.

### DETAILED DESCRIPTION

Various embodiments according to the invention will be described hereinafter with reference to the accompanying drawings. In general, according to one embodiment of the invention, a control device that controls operation of a system comprises a first selecting module, a second selecting module, a control error measuring module, a determining module, and a control module. The first selecting module is configured to select a first neural network from a plurality of neural networks which are different in network configuration from each other. The second selecting module is configured to select a second neural network different from the first neural network from the neural networks. The control error measuring module is configured to measure first control error in control by the first neural network and second control error in control by the second neural network. The determining module is configured to compare the first control error and the second control error measured by the control error measuring module, and determine a neural network with less control error. The control module is configured to control the operation of the system by the neural network with less control error determined by the determining module.

According to another embodiment of the invention, a control method of controlling operation of a system comprises: selecting a first neural network from a plurality of neural networks which are different in network configuration from each other; selecting a second neural network different from the first neural network from the neural networks; measuring first control error in control by the first neural network and second control error in control by the second neural network; comparing the first control error and the second control error measured at the measuring to determine a neural network with less control error; and controlling the operation of the system by the neural network with less control error.

According to still another embodiment of the invention, there is provided a computer program product that implements the above method.

### First Embodiment

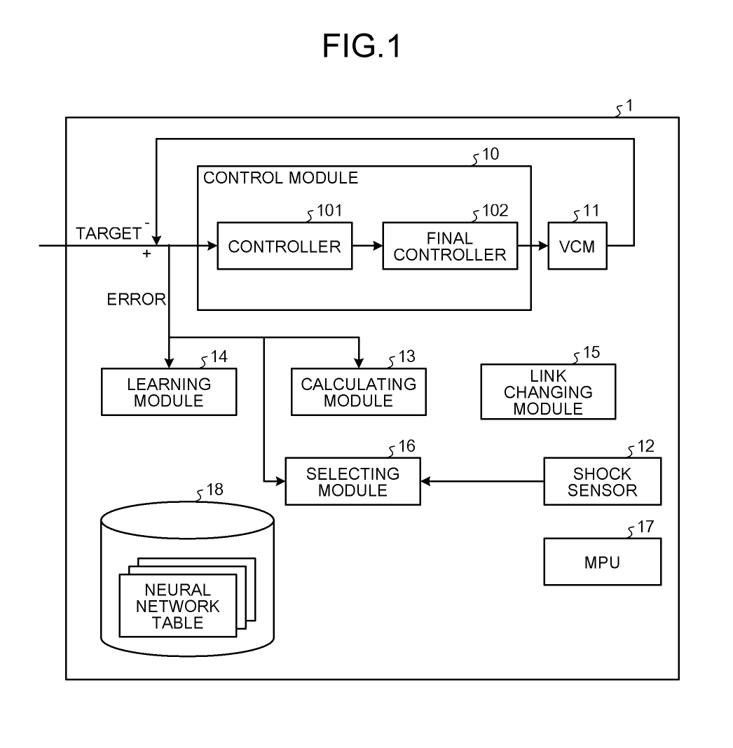

FIG. 1 is a block diagram of a disk device according to a first embodiment of the invention. As illustrated in FIG. 1, a disk device 1 (control device) according to this embodiment comprises a control module 10, a voice coil motor (VCM) 11, a shock sensor 12 (detecting module), a calculating module 13 (control module), a learning module 14 (a weight correcting module and a control error measuring module), a link changing module 15 (a link excluding module and a link introducing module), a selecting module 16 (a first selecting module, a second selecting module, an associating module, and a control error measuring module), a micro processing unit (MPU) 17, and a storage medium 18.

The VCM 11 that is a control object in this embodiment drives a magnetic head (not illustrated). The control module 10 comprises a controller 101 that controls the VCM 11 serving as the control object and a final controller 102 that adds a correction by a neural network to the control amount by the controller. Further, the storage medium 18 stores neural network tables 18 that are neural network parameters. The storage medium 18 may be any one of a magnetic disk (not illustrated) and a nonvolatile memory (for example, flash memory) provided in the device. Further, the learning module 14 learns the neural network, on the basis of an error (control error) of a feedback of the VCM 11 with respect to control by the control module 10 and a target value. The learning of the neural network is a process that corrects weights of links between nodes in the neural network based on the control error. Further, the calculating module 13 calculates a correction value of the control amount, on the basis of the neural network. Further, the link changing module 15 invalidates or validates the link of the neural network. Further, the shock sensor 12 detects disturbance with respect to the disk device 1. The selecting module 16 selects the predetermined neural network from the neural networks, on the basis of the disturbance detection from the shock sensor 12. The MPU 17 executes a process in the disk device 1, and the individual functions of the calculating module 13, the learning module 14, the link changing module 15, and the selecting module 16 are substantially executed by the MPU 17.

As described above, the disk device 1 of the first embodiment has the configuration where an error correction by the neural network control is input to the conventional control controller (control module 10). This configuration is to provide the outline by the conventional control controller. According to the first embodiment, first, the control operation is performed by the conventional control controller that is currently used. In addition, a complicated error portion that cannot be controlled by the conventional control controller is compensated by a nonlinear or learning suitable neural network. The configuration of the disk device 1 of the first embodiment is only exemplary, and the disk device 1 may have the configuration where control by only the neural network is performed.

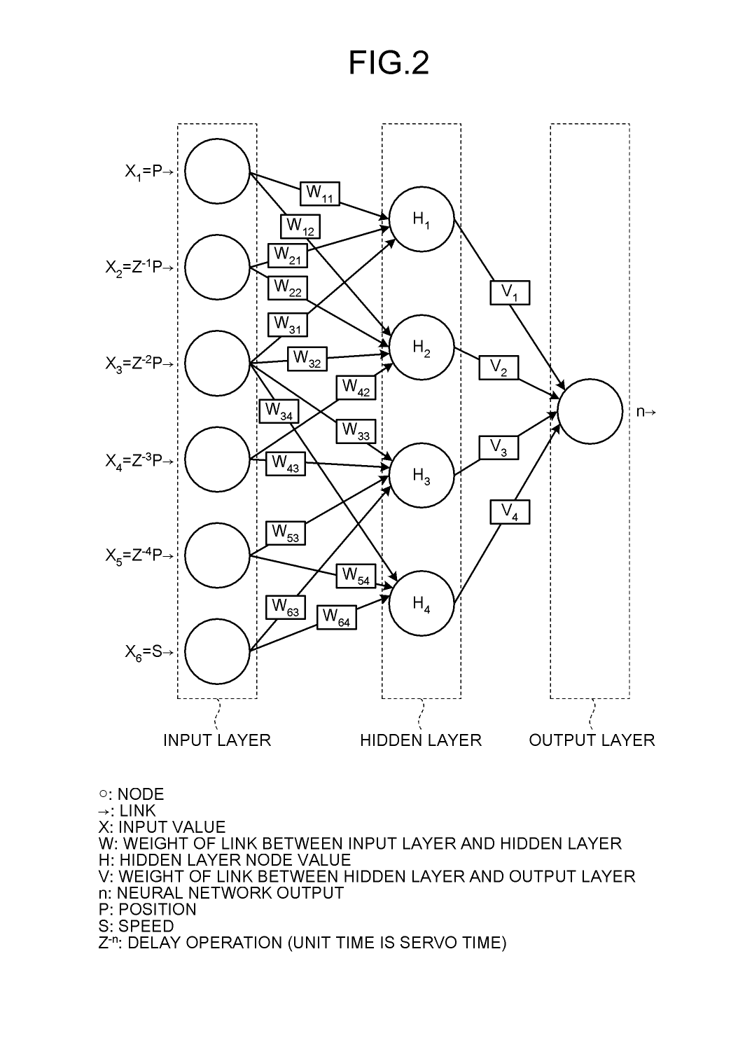

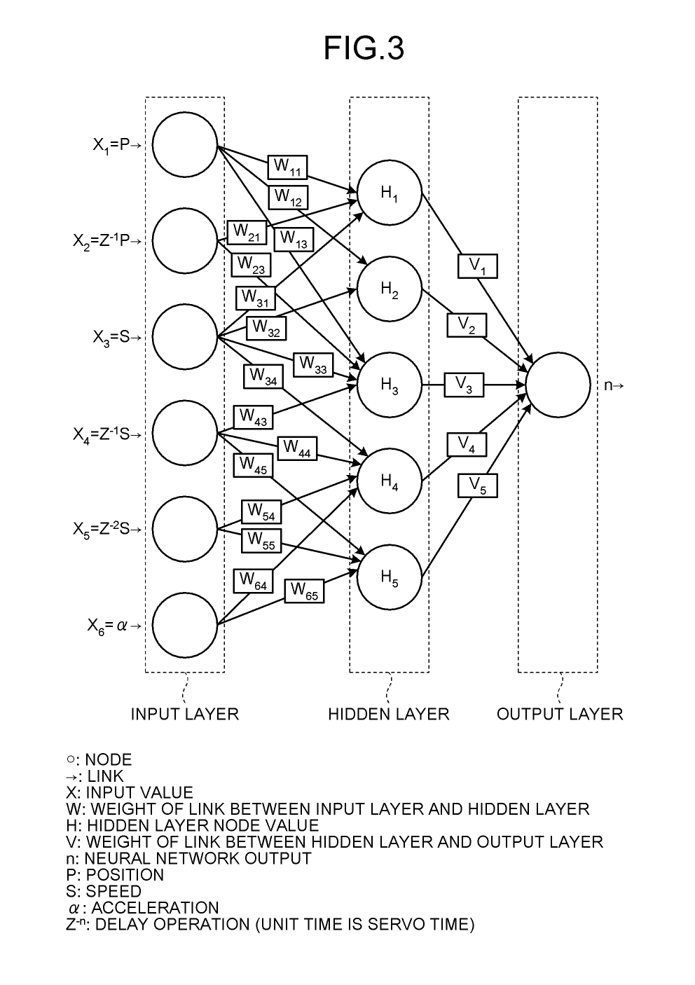

Next, the neural network that is used in the first embodiment will be described. FIG. 2 is a diagram of a neural network A. FIG. 3 is a diagram of a neural network B.

The first embodiment employs the neural network A that is used when the amount of disturbance is small and the neural network B that is used when the amount of disturbance is large. The neural network A is a 6-4-1 hierarchical neural network that uses a position P, a position Z⁻ⁿP where a delay operation using a servo time as a unit time is applied, and a speed S as input values, as illustrated in FIG. 2. Further, the neural network B is a 6-5-1 hierarchical neural network that uses a position P, a position Z⁻ⁿP where a delay operation Z⁻ⁿ using a servo time as a unit time is applied, a speed S, a speed Z⁻ⁿS where the delay operation Z⁻ⁿ is applied, and an acceleration a as input values, as illustrated in FIG. 3.

As such, parameters of the neural networks where types of input values and the configurations by nodes and links are different from each other are stored as neural network tables in the storage medium 18. Further, if the neural networks corresponding to different conditions are switched according to the corresponding conditions, only the parameters according to the conditions can be input. As a result, a calculation load can be suppressed while usability is ensured.

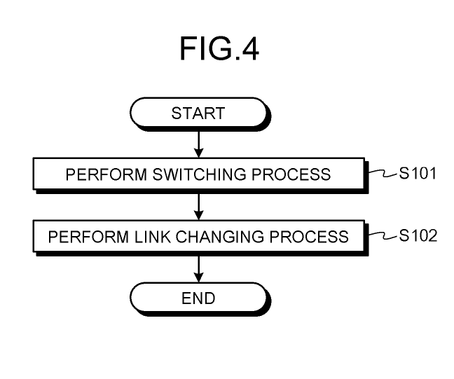

Next, the operation of the disk device of the first embodiment will be described. FIG. 4 is a flowchart of the entire operation of a disk device of the first embodiment.

First, the selecting module 16 executes a switching process to be described in detail below (S101). Next, the link changing module 15 executes a link changing process to be described in detail below (S102). During the switching process and the link changing process, a learning process by the learning module 14 is executed. The learning process, i.e., the learning process in the conventional neural network, changes the link weight by the above-described error back-propagation method.

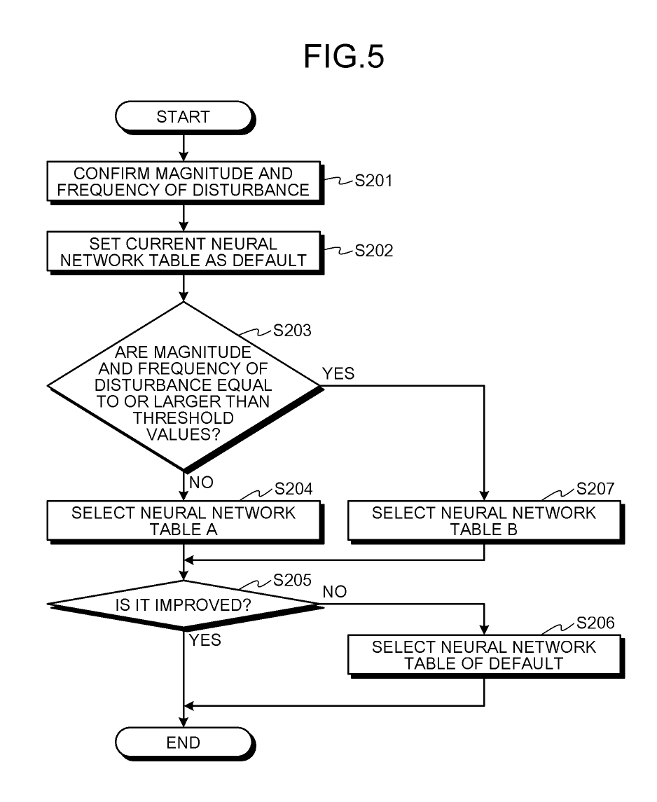

Next, the switching process will be described. FIG. 5 is a flowchart of the operation of a switching process. The switching process is a process in S104 of FIG. 4.

First, the selecting module 16 confirms the magnitude and frequency of disturbance by the shock sensor (parameters of the disturbance) (S201), defaults the selected neural network table (first selecting step, S202), and determines whether the magnitude and frequency of the disturbance are equal or to more than threshold values (S203).

When the magnitude and frequency of the disturbance are smaller than the threshold values (NO at S203), the selecting module 16 selects the neural network table A as the parameter of the neural network of when the amount of disturbance is small (second selecting step, S204), and determines whether the control corrected by the neural network A is improved with respect to the control corrected by the neural network of the default (a control error measuring step and a determining step, S205). The determination on whether the control is improved is performed by measuring a control error by the selecting module 16. Specifically, the selecting module 16 refers to an error based on a control target value and an actual control value by the VCM 11, and uses the error as a control error. That is, the improvement means that the control error is lowered.

When the control is improved (YES at S205), the selecting module 16 completes the switching process.

Meanwhile, when the control is not improved (NO at S205), the selecting module 16 selects the neural network table of the default (S206).

When the magnitude and frequency of the disturbance are equal to or larger than the threshold values in S203 (YES at S203), the selecting module 16 selects the neural network table B as the parameter of the neural network of when the amount of disturbance is large (second selecting step, S206).

On the basis of the correction value by the switched neural network and the control parameter by the controller 101, the control of the VCM 11 is performed by the final controller 102 (control step). If the neural network is switched, control where usability is high and a calculation load is small is enabled. In the first embodiment, the two neural networks are switched using the magnitude and frequency of the disturbance as a trigger. However, this case is only exemplary, and a kind of the trigger and the number of neural networks are not limited. For example, the neural network may be switched for every predetermined time.

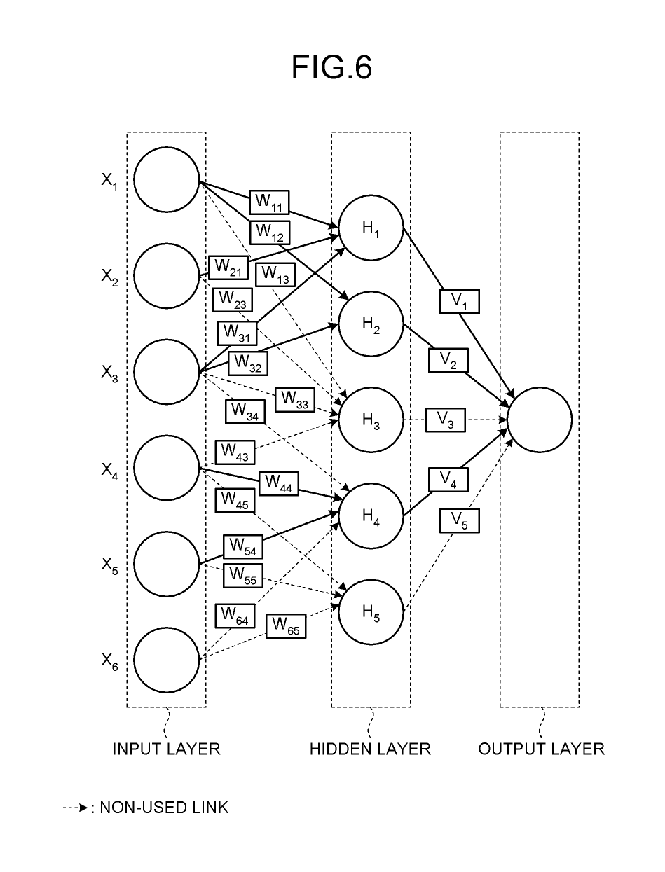

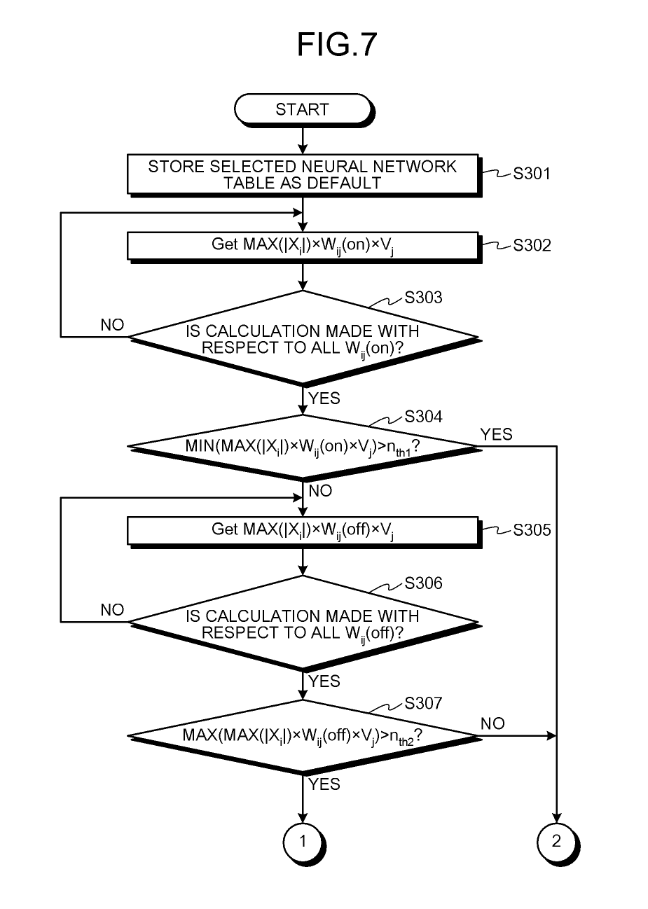

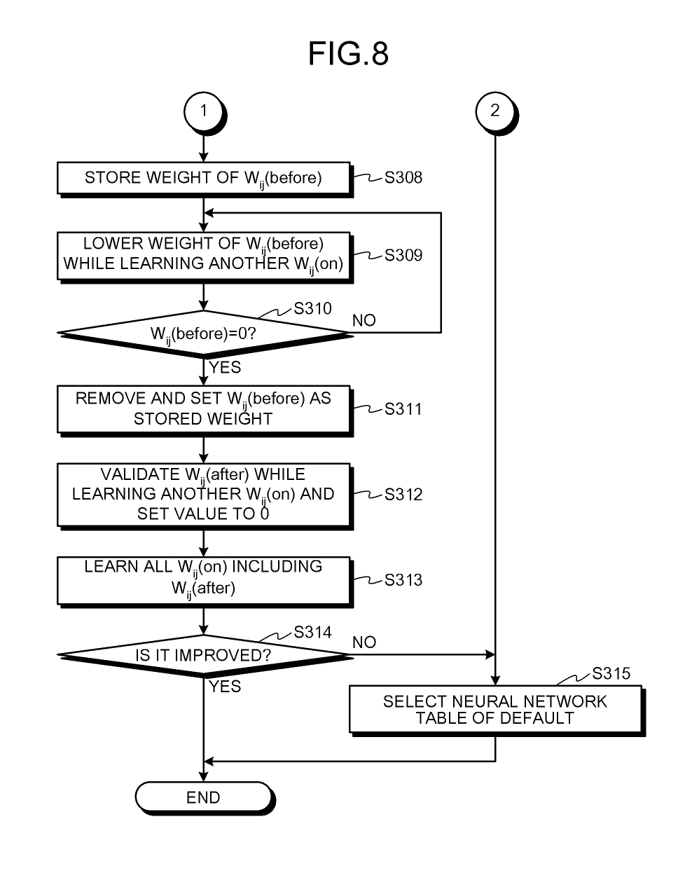

Next, the link changing process will be described. FIG. 6 is a diagram of the outline of a link changing process. FIGS. 7 and 8 are flowcharts of the operation of a link changing process.

The link changing process is a process that validates or invalidates links between input nodes and hidden nodes, and the hidden nodes and an output node, as illustrated in FIG. 6. Hereinafter, the operation of the link changing process will be described using FIGS. 7 and 8. In FIGS. 7 and 8, MAX( )indicates a MAX function and MIN( )indicates a MIN function. The MAX function is a function that calculates a maximum value in subsequent parentheses, and the MIN function is a function that calculates a minim value in subsequent parentheses. In FIGS. 7 and 8, nₜₕ₁ indicates a threshold value that is used to extract a candidate of an invalided link. Further, nₜₕ₂ indicates a threshold value (second threshold value) for link validation. Further, Wᵢⱼ(on) indicates validated link weight and Wᵢⱼ(off) indicates invalidated link weight. Wᵢⱼ(before) indicates link weight having the possibility of being invalidated, among validated link weights. Wᵢⱼ(after) indicates link weight having the possibility of being validated, among invalidated link weights. In FIGS. 7 and 8, it is assumed that the link changing is performed on only the links between the input nodes and the hidden nodes for convenience. It is assumed that the correction of the weight by the learning module 14 is already performed (weight correcting step).

First, the link changing module 15 stores the selected neural network table as a default (S301), multiplies a maximum value of the input value Xᵢ by Wᵢⱼ(on) and Vⱼ (S302), and determines whether a calculation is made with respect to all Wᵢⱼ(on) (S303).

When the calculation is performed with respect to all Wᵢⱼ(on) (YES at S303), the link changing module 15 determines whether a minimum value in values calculated in S302 is larger than nₜₕ₁ (S304).

When the minimum value in the values calculated in S302 is smaller than or equal to nₜₕ₁ (NO at S304), the link changing module 15 multiplies the maximum value of the input value Xᵢ by Wᵢⱼ(off) and Vⱼ (S305), and determines whether a calculation is made with respect to all Wᵢⱼ(off) (S306).

When the calculation is performed with respect to all Wᵢⱼ(off) (YES at S306), the link changing module 15 determines whether a maximum value in values calculated in S305 is larger than nₜₕ₂ (S307).

When the maximum value in the values calculated in S305 is larger than nₜₕ₂ (YES at S307), the link changing module 15 sets Wᵢⱼ(on) becoming nₜₕ₁ or less in S307 as Wᵢⱼ(before) and stores the weight thereof (S308). The link changing module 15 lowers the weight of Wᵢⱼ(before) by the predetermined value while allowing the learning module 14 to learn the other Wᵢⱼ(on) (S309), and determines whether Wᵢⱼ(before)=0 (first threshold value) is satisfied (S310).

When Wᵢⱼ(before)=0 is satisfied (YES at S310), the link changing module 15 invalidates the link of Wᵢⱼ(before) (link excluding step), and sets the weight thereof as the value stored in S308 (S311).

Next, the link changing module 15 sets Wᵢⱼ(off) becoming larger than nₜₕ₁ in S307 as Wᵢⱼ(after), validates the link of Wᵢⱼ(after) while allowing the learning module 14 to learn the other Wᵢⱼ(on) (link introducing step), and sets a value thereof as 0 (S312).

Next, the link changing module 15 allows the learning module 14 to learn all Wᵢⱼ(on) including Wᵢⱼ(after) (S313), and determines whether the control by the neural network where the link is changed is more improved than the control by the neural network of the default (S314).

When the control is more improved than the control by the neural network of the default (YES at S314), the link changing module 15 completes the link changing process.

Meanwhile, when the control is not more improved than the control by the neural network of the default (NO at S314), the link changing module 15 selects the neural network table of the default (S315).

Further, when Wᵢⱼ(before)=0 is not satisfied in S310 (NO at S310), the link changing module lowers the weight of Wᵢⱼ(before) by the predetermined value while allowing the learning module 14 to learn the other Wᵢⱼ(on) (S309).

When the maximum value in the values calculated in S305 is smaller than or equal to nₜₕ₂ in S307 (NO at S307), the link changing module 15 selects the neural network table of the default (S315).

When the minimum value in the values calculated in S302 is larger than nₜₕ₁ in S304 (YES at S304), the link changing module 15 selects the neural network table of the default (S315).

When the calculation is not made with respect to all Wᵢⱼ(on) in S303 (NO at S303), the link changing module 15 multiplies the maximum value of the input value Xᵢ by Wᵢⱼ(on) and Vⱼ, with respect to Wᵢⱼ(on) different from Wᵢⱼ(on) that is already calculated (S302).

As described above, the unnecessary links are removed by invalidating the links on the basis of the weights of the links. As a result, a load that is related to the neural network control can be reduced. Further, according to the above-described process, when the invalided links are effective, the links can be validated.

### Second Embodiment

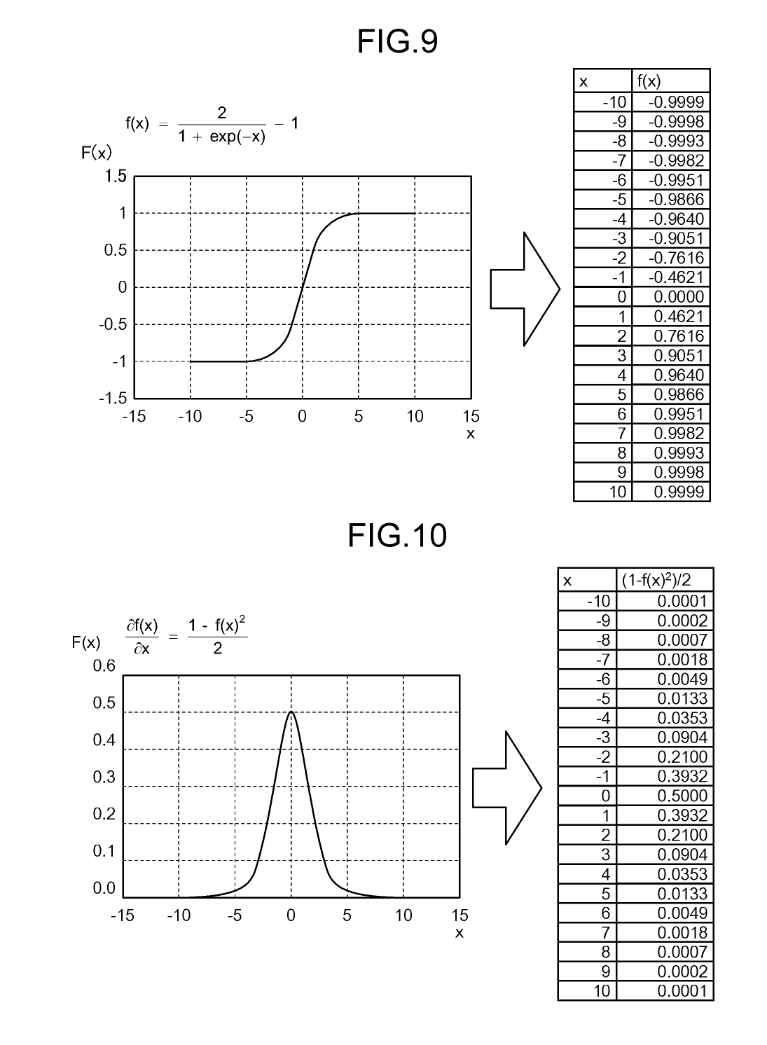

In the first embodiment, a function value based on the sigmoid function as the logistic function in the neural network is calculated, if necessary. However, in a second embodiment of the invention, a function value based on a sigmoid function and a derived function thereof is configured in a form of a look-up table. In this point, the second embodiment is different from the first embodiment. The description of the similar configuration and operation as those in the first embodiment will be omitted. FIG. 9 is a diagram of a look-up table of a sigmoid function. FIG. 10 is a diagram of a look-up table of a derived function of a sigmoid function.

The look-up table illustrated in FIGS. 9 and 10 is a table where values (function values) previously calculated with respect to a sigmoid function and a derived function thereof are associated with input values x, and is stored in the storage medium 18 in advance and managed. The calculating module 13 in the disk device 1 of the second embodiment sets a value of f(x) or (1−f(x)²/2) as a value associated with x in the look-up table, thereby alleviating a process load. The look-up table can be applied to a previously calculated expression, in the neural network control.

### Third Embodiment

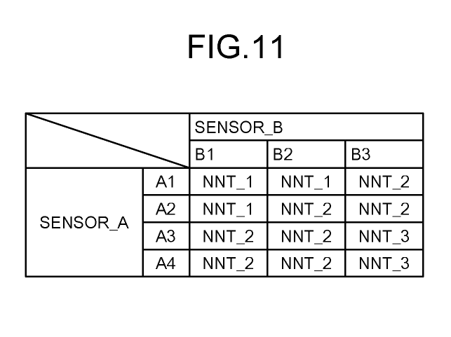

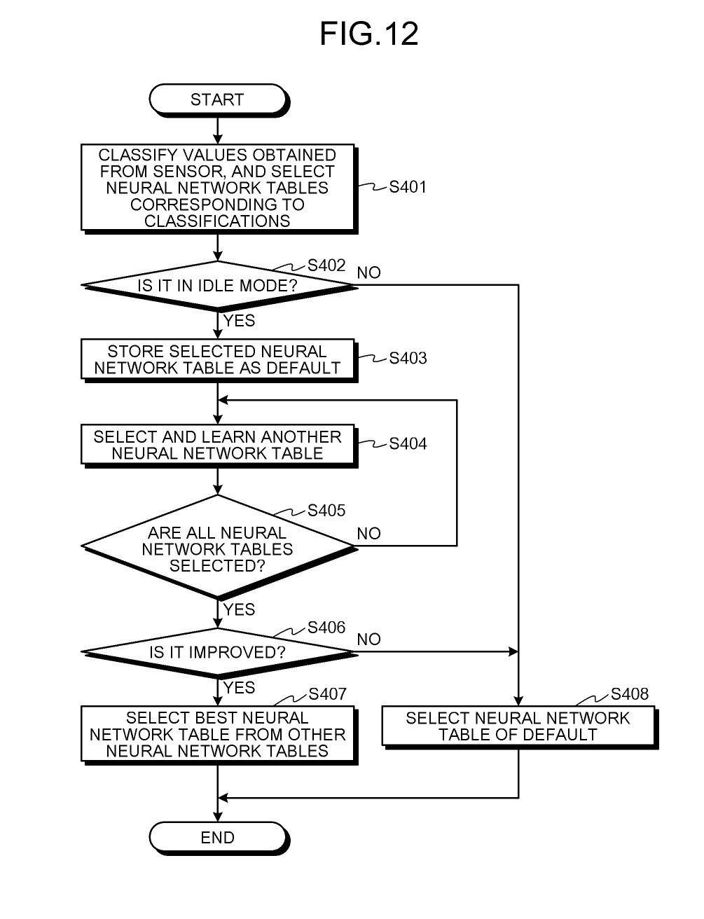

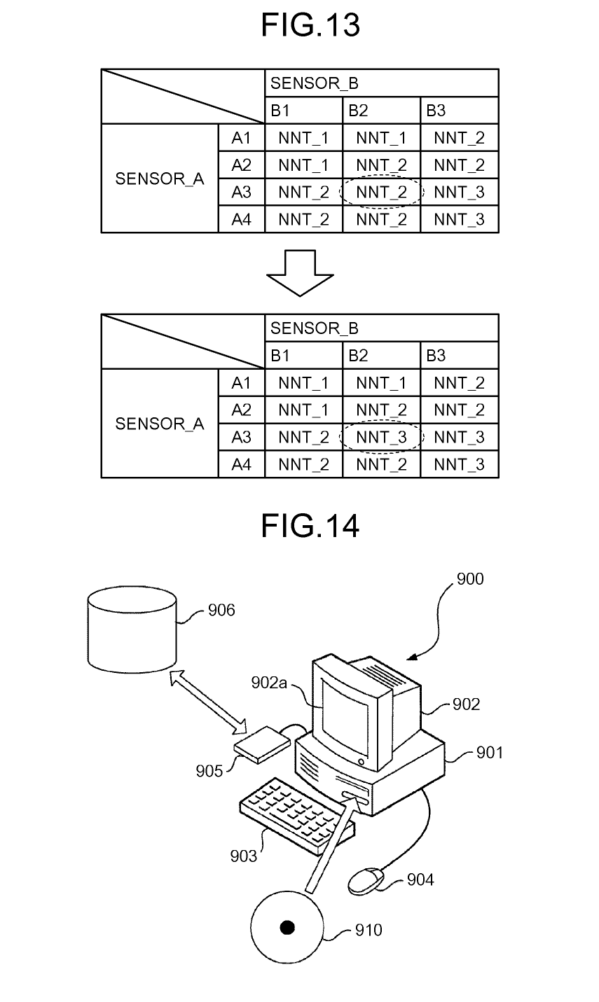

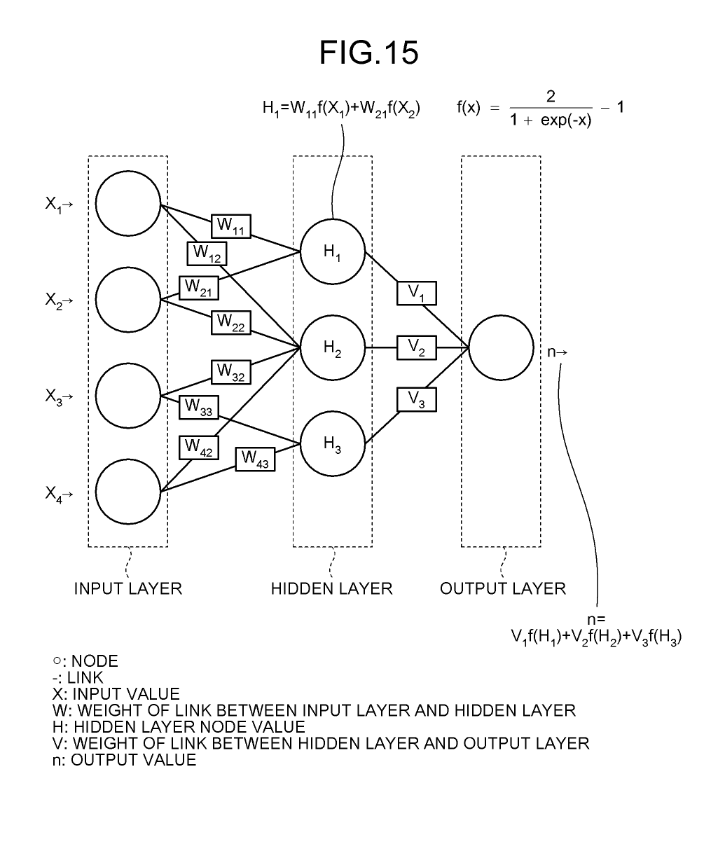

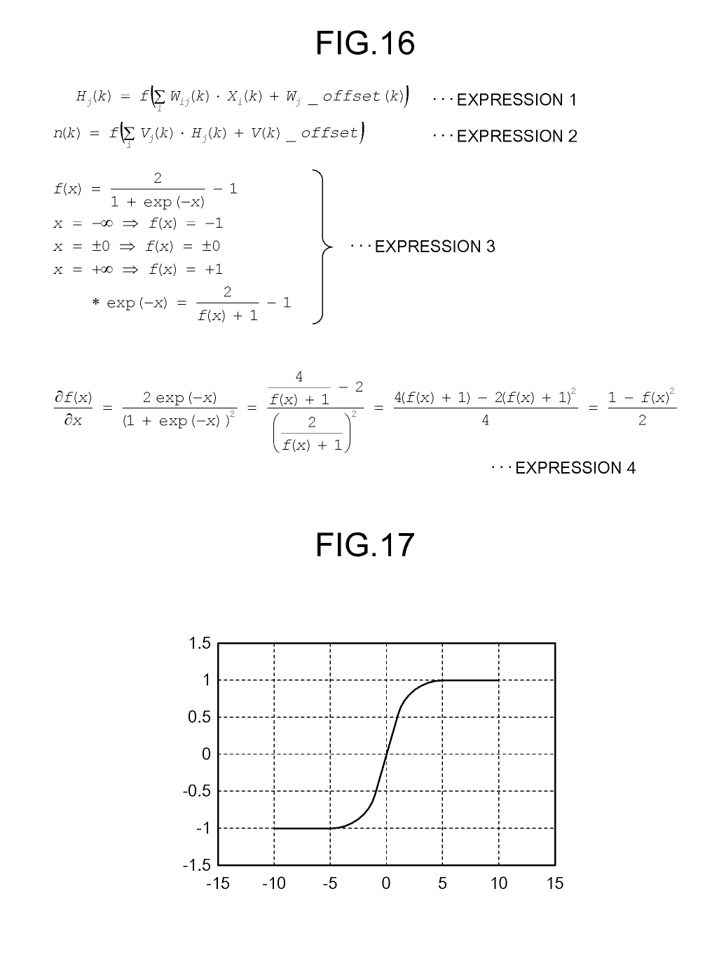

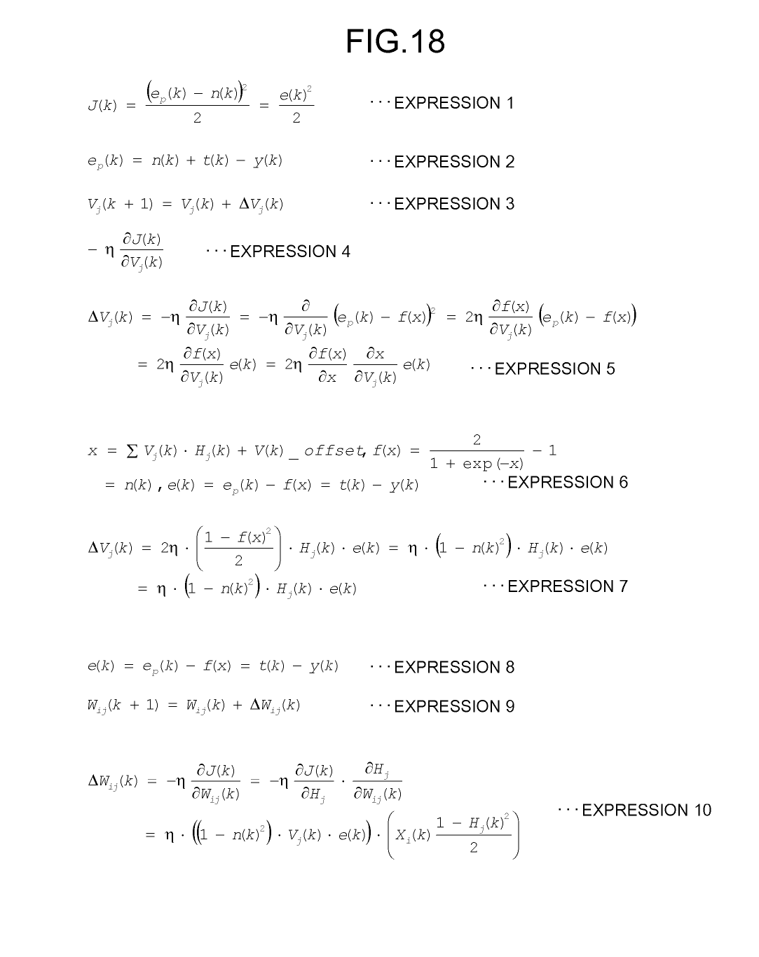

In the first and second embodiments, the disturbance is detected by one shock sensor 12, and the neural network table is selected on the basis of the magnitude and frequency of the detected disturbance. Meanwhile, a third embodiment of the invention is different from the first and second embodiments in that the shock sensor 12 is configured by a plurality of shock sensors (sensors A and B), and the neural network table is selected on the basis of parameters of a plurality of disturbances obtained by the shock sensor 12. Hereinafter, the configuration and operation that are different from those in the first and second embodiments will be described. FIG. 11 is a diagram of a classification table. FIG. 12 is a flowchart of the operation of a switching process in the third embodiment. FIG. 13 is a diagram of a changed classification table.

In the disk device 1 of the third embodiment, the shock sensor 12 is configured by the sensors A and B, as described above. As a table used to select the neural network, the classification table illustrated in FIG. 11 is used. In the classification table, combinations of classifications A1 to A4 in the sensor A and classifications B1 to B3 in the sensor B, and three neural network tables are associated with each other. Further, the classification table is stored in the storage medium 18. Further, the classifications in the classification table are based on the magnitude and frequency of the disturbance that is detected by the sensors A and B. In the third embodiment, the classifications indicate ranges of the disturbances, respectively, and the ranges do not overlap each other.

Next, a switching process in the third embodiment will be described.

First, the selecting module 13 classifies values obtained by the sensors A and B on the basis of a predetermined range, selects the neural network table corresponding to the classification in the classification table (S401), and determines whether the disk device 1 is in an idle mode (S402).

When the disk device 1 is in the idle mode (YES at S402), the selecting module 16 stores the selected neural network table as the default (S403), selects another neural network table, and allows the learning module 14 to learn another neural network table (S404). In this case, the selecting module 16 determines whether all the neural network tables are selected in S404 (S405).

When all the neural network tables are selected (YES at S405), the selecting module 16 determines whether control by any one of the other neural networks is improved with respect to the control by the neural network of the default (S406). The determination on whether the control is improved is performed on the basis of the control error, as described in the first embodiment.

When the control by any one of the other neural networks is improved (YES at S406), a best table is selected by the other neural networks (S407). Specifically, as illustrated in FIG. 13, the selecting module 16 replaces a neural network table (NNT 2 in FIG. 13) in the classification table as the default with the selected best neural network table (NNT 3 in FIG. 13). In this case, the best neural network table indicates a neural network table that can realize control similar to the most targeted control. The selecting module 16 that has selected the best neural network table completes the switching process.

Meanwhile, when the control by any one of the other neural networks is not improved (NO at S406), the selecting module 16 selects the neural network table of the default (S408), and completes the switching process.

When all the neural network tables are not selected in S405 (NO at S405), the selecting module 16 selects another neural network table and allows the learning module 14 to learn another neural network table again (S404).

When the disk device 1 is not in the idle mode in S402, (NO at S402), the selecting module 16 selects the neural network table of the default (S408).

As described above, by selecting the neural network table on the basis of the disturbances, control can be performed with high precision and a process load can be alleviated.

The above processes can be implemented by executing a program (hereinafter, “control program”) on the MPU 17 of the disk device 1 or the computer system. The control program may be stored in a storage medium readable by the computer system so that the computer system can execute the control program. The control program that can be read by the computer system may be stored in the storage medium 18 of the disk device 1 through the computer system. Further, as illustrated in FIG. 14, the control program may be stored in a portable storage medium such as a disk 910 or downloaded from a storage medium 906 of another computer system by a communication device 905. Further, a control program (control software) that provides a computer system 900 with at least a control function is input to the computer system 900 and compiled. The control program allows the computer system 900 to operate as a control system having a control function. The control program may be stored in a computer readable storage medium such as the disk 910. Examples of the storage medium readable by the computer system 900 include an internal storage device mounted in a computer such as ROM or RAM, a flexible disk, a DVD disk, a magneto optical disk, a portable storage medium such as an IC card, a database to store a computer program, other computer systems and a database thereof, and various recording media that is accessible in a computer system connected through a communication mechanism, such as the communication device 905.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control device that controls operation of a system, comprising:
a first selecting module configured to select a first neural network from a plurality of neural networks which are different in network configuration from each other;
a second selecting module configured to select a second neural network different from the first neural network from the neural networks;
a control error measuring module configured to measure first control error in control by the first neural network and second control error in control by the second neural network;
a determining module configured to compare the first control error and the second control error measured by the control error measuring module, and determine a neural network with less control error; and
a control module configured to control the operation of the system by the neural network with less control error determined by the determining module.

2. The control device according to claim 1, wherein the neural networks are each configured of a plurality of nodes and links between the nodes, the control device further comprising:
a weight correcting module configured to correct weight set to the links in the neural network used by the control module to control the operation of the system based on the first control error or the second control error measured by the control error measuring module;
a link excluding module configured to exclude links where a value based on the weight is smaller than or equal to a first threshold value from the links weight of which is corrected by the weight correcting module; and
a link introducing module configured to introduce links where a value based on the weight is larger than a second threshold value different from the first threshold value from the links excluded by the link excluding module.

3. The control device according to claim 1, further comprising a detecting module configured to detect disturbance of the system, wherein
the second selecting module is configured to select the second neural network based on a parameter of the disturbance detected by the detecting module.

4. The control device according to claim 1, further comprising a plurality of shock sensors configured to detect disturbances of the system, wherein
the first neural network is associated with a combination of parameters of the disturbances detected by the shock sensors, and
the second control error of the second neural network is lowest among control errors of the neural networks other than the first neural network.

5. The control device according to claim 4, further comprising an associating module configured to associate the combination of the parameters of the disturbances associated with the first neural network and the second neural network when the determining module determines that the second control error is lower than the first control error.

6. The control device according to claim 1, wherein the control module is configured to refer to a look-up table, in which an input value in a function related to the neural network and a function value based on the input value are associated with each other, in calculation related to the neural network, and obtains the function value associated with the input value using the input value as an argument.

7. The control device according to claim 1, wherein
the system is a disk device, and
the control module is configured to control a voice coil motor of the disk device.

8. A computer program product embodied on a computer-readable medium and comprising code to control operation of a system, the code, when executed, causing a computer to perform:
first selecting a first neural network from a plurality of neural networks which are different in network configuration from each other;
second selecting a second neural network different from the first neural network from the neural networks;
measuring first control error in control by the first neural network and second control error in control by the second neural network;
comparing the first control error and the second control error measured at the measuring to determine a neural network with less control error; and
controlling the operation of the system by the neural network with less control error.

9. The computer program product according to claim 8, wherein
the neural networks are each configured of a plurality of nodes and links between the nodes, and
the code further causing the computer to perform:
correcting weight set to the links in the neural network used to control the operation of the system at the controlling based on the first control error or the second control error measured at the measuring;
excluding links where a value based on the weight is smaller than or equal to a first threshold value from the links weight of which is corrected at the correcting; and
introducing links where a value based on the weight is larger than a second threshold value different from the first threshold value from the links excluded at the excluding.

10. The computer program product according to claim 8, wherein
the code further causing the computer to perform detecting disturbance of the system, and
the second selecting includes selecting the second neural network based on the disturbance of the system detected at the detecting.

11. The computer program product according to claim 8, wherein
the code further causing the computer to perform detecting disturbances of the system by a plurality of shock sensors,
the first neural network is associated with a combination of parameters of the disturbances detected at the detecting, and
the second control error of the second neural network is lowest among control errors of the neural networks other than the first neural network.

12. The computer program product according to claim 11, wherein the code further causing the computer to perform associating the combination of the parameters of the disturbances associated with the first neural network with the second neural network when it is determined that the second control error is lower than the first control error.

13. The computer program product according to claim 8, wherein the controlling includes referring to a look-up table, in which an input value in a function related to the neural network and a function value based on the input value are associated with each other, in calculation related to the neural network, and obtaining the function value associated with the input value using the input value as an argument.

14. The computer program product according to claim 8, wherein
the system is a disk device, and
the controlling includes controlling a voice coil motor of the disk device.

15. A control method of controlling operation of a system, comprising:
first selecting a first neural network from a plurality of neural networks which are different in network configuration from each other;
second selecting a second neural network different from the first neural network from the neural networks;
measuring first control error in control by the first neural network and second control error in control by the second neural network;
comparing the first control error and the second control error measured at the measuring to determine a neural network with less control error; and
controlling the operation of the system by the neural network with less control error.

16. The control method according to claim 15, wherein the neural networks are each configured of a plurality of nodes and links between the nodes, the method further comprising:
correcting weight set to the links in the neural network used to control the operation of the system at the controlling based on the first control error or the second control error measured at the measuring;
excluding links where a value based on the weight is smaller than or equal to a first threshold value from the links weight of which is corrected at the correcting; and
introducing links where a value based on the weight is larger than a second threshold value different from the first threshold value from the links excluded at the excluding.

17. The control method according to claim 15, further comprising detecting disturbance of the system, wherein
the second selecting includes selecting the second neural network based on the disturbance of the system detected at the detecting.

18. The control method according to claim 15, further comprising detecting disturbances of the system by a plurality of shock sensors, wherein
the first neural network is associated with a combination of parameters of the disturbances detected at the detecting, and
the second control error of the second neural network is lowest among control errors of the neural networks other than the first neural network.

19. The control method according to claim 18, further comprising associating the combination of the parameters of the disturbances associated with the first neural network with the second neural network when it is determined that the second control error is lower than the first control error.

20. The control method according to claim 15, wherein the controlling includes referring to a look-up table, in which an input value in a function related to the neural network and a function value based on the input value are associated with each other, in calculation related to the neural network, and obtaining the function value associated with the input value using the input value as an argument.
